(19) United States
(12) Patent Application Publication
(10) Pub. No.: US 2003/0158757 A1
(43) Pub. Date: Aug. 21, 2003

(54) Rules and constraint based management of work

(76) Inventor: Yuri Shtivelman, San Francisco, CA (US)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 10/198,504

(22) Filed: Jul. 17, 2002

Related U.S. Application Data
(60) Provisional application No. 60/358,854, filed on Feb. 21, 2002.

(51) Int. Cl. G06F 17/60

(52) U.S. Cl. 705/4; 705/9

(57) ABSTRACT

The invention provides a method for processing a task. The method comprising rules which constrain an allocation of the task; defining constraints which constrain application of the rules; expressing the allocation of the task as a constraint satisfaction problem based on the rules and the constraints; and resolving the constraint satisfaction problem.

### CLAIM OF PRIORITY

This application is related to, and hereby claims the benefit of provisional application No. 60/358,854 which was filed Feb. 21, 2002.

### FIELD

This invention relates to work flow management within enterprises. In particular it relates to the allocation and prioritization of tasks within enterprises such as insurance companies.

### BACKGROUND

The present invention will be described with reference to an insurance company in order to facilitate understanding. However, it should be borne in mind that the invention applies equally to other types of enterprises that manage workflow from a central location such as a call center. Such enterprises include, but are not limited to, financial services companies, telecommunication services companies, transportation companies, and retail services companies.

Insurance companies deal with hundreds or even thousands of claims every day and may have thousands of adjustors, located in hundreds of offices across the country to facilitate processing of the claims. Insurance companies may also have hundreds of operators in call centers accepting damage claims over the phone and redirecting those claims to offices that must somehow, mostly haphazardly, divide the workload among adjustors in those offices.

FIG. 1 shows an overview of such a system as is currently in practice in the industry. Element 110 is John D. Public (John Doe Public), representing customers of the insurance company and people who have been injured or have had property damage by customers of the insurance companies. Such members of the public file claims either by directly approaching one of the claim centers, such as one of centers 101a-d (in reality, as mentioned above, there may be hundreds or even more of them) or by calling an 800 number that typically goes to one of multiple call centers 100 (only one center is shown, for clarity and simplicity). From such call centers the claims are then redistributed to the claim centers 101a-d, typically by geography or type of coverage (i.e. Home vs. Auto etc.).

This process has many shortcomings, including the following:

1. it typically tries to allocate a specific number of cases to each adjustor, rather than consider the complexity of each case;

2. an adjustor may receive multiple claims from the same client and as a result, may develop a relationship with the client (positive or negative) and hence no longer treat the claims objectively.

3. even though a claim may originate in one geographical area, the actual damage may have occurred in a different geographical area. Therefore, simplistic geographical assignments of claims may not always be correct.

The fundamental cause for such shortcomings is that when a claim is received, not all the issues and information associated with the claim are readily available. Thus, the workload distribution process may be very haphazard. Further, in addition to distributing the claims through the enterprise, there is a problem of task execution for an individual adjuster. Each adjuster might be working on 50-100 claims at the same time. Claims processing consists of a number of tasks, like collection of information from field adjusters, medical records, court papers, checking coverage, making phone calls, writing emails, etc. Presently, it is up to the adjuster to choose what tasks to perform.

There is thus a need for a more efficient workload distribution process whereby tasks are allocated to various individuals within an enterprise.

There is also a need for a system that will prioritize these tasks according to a set of business rules.

### SUMMARY

According to one aspect there is provided a method comprising defining rules which constrain an allocation of the task; defining constraints which constrain application of the rules; expressing the allocation of the task as a constraint satisfaction problem based on the rules and the constraints; and resolving the constraint satisfaction problem.

Other features and advantages of the present invention will be apparent from the accompanying drawings, and from the detailed description, that follows below.

### BRIEF DESCRIPTION OF THE DRAWINGS

FIG. 1 illustrates how tasks are allocated in a prior art method; and

FIG. 2 shows a block diagram of a system for allocating tasks in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one case” or “a case” means that a particular feature, structure, or characteristic described in connection with the case is included in at least one case of the invention. The appearances of the phrase “in one case” in various places in the specification are not necessarily all referring to the same case, nor are separate or alternative cases mutually exclusive of other cases. Moreover, various features are described which may be exhibited by some cases and not by others. Similarly, various requirements are described which may be requirements for some cases but not other cases.

For the purposes of this specification, a “service organization” shall mean any organization that sells or renders a service including, but not limited to, financial services companies, insurance companies, telecommunication service companies, transportation companies, and retail service companies.

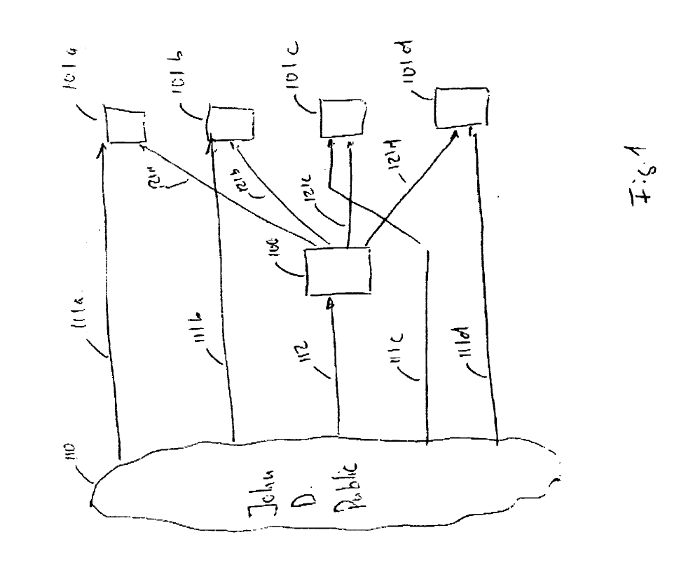

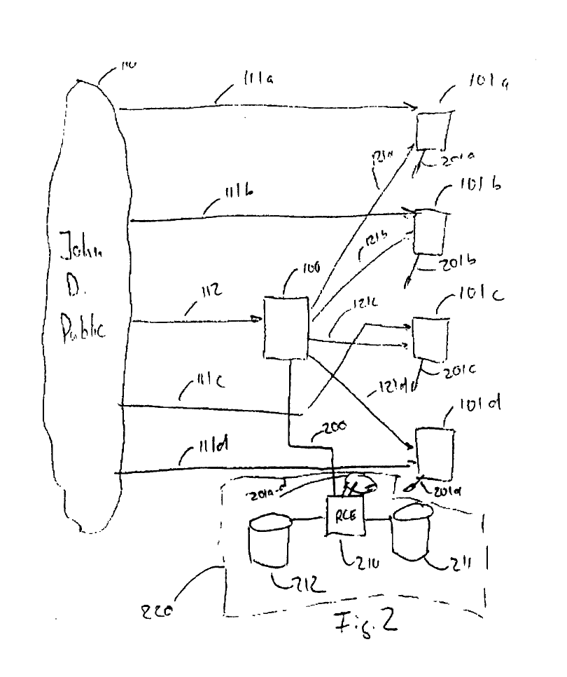

FIG. 2 shows the same system as is shown in FIG. 1, but with a central computing system 220 added. In reality, this system 220 need not be a centralized system, but instead may be a loosely networked combination of multiple centers. In fact, most financial services companies, which includes insurance companies, has more than one center to maintain operations in times of crises, such as following a natural disaster, hostile attack, etc. However, for reasons of simplicity in this illustration of the embodiment, only one center is shown.

This center 220 has access via a central computer 210 to enterprise data 211, which contains information about all the customers of the enterprise, including types and amounts of protection and coverage, potential history of damages, etc. It also contains a rules and constraints database 212, which contains a set of rules and constraints by which the assignment of claims is handled.

RCE is a particular software instance of a rules and constraints engine, sitting in computer 210 and connected via lines 200 and 200a-d to the central call center as well as to local claims offices. Enterprise data system 211 may contain information about current work loads and also about customers and clients assigned presently and in the past to various adjustors.

For example, should a related claim arise in the same area, the software instance could try to send the two claims to the same adjustor to simplify handling, rather than requiring that two different adjustors each learn the whole background of the case to deal with it.

The rules and constraints engine, and related techniques described in co-pending applications (U.S. Ser. Nos. 09/953,701, 09/953,697 and 09/952,821) are suitable in implementing embodiments of the present invention and are incorporated herein by reference.

As new laws may emerge, or as operating procedures may change, rather than having to reprogram various complex systems, all that is required is to update the rules and constraints in database 212 to change the work flow of claims management accordingly.

Other examples may include rules, by which customers that have coverage above a certain amount receive a preferred service, but constraint with a enhanced supervisory scrutiny by a regional over sight center (not shown).

In yet other cases, small claims may be settled over the phone, provided no payout has been made to this customer in the last 5 years. However state law in the state of that customer may require all cases up to $500 to be handled by phone. Hence there may be conflicting rules.

In some cases, the system will use RCE to determine also which tasks agents have to perform, in order for the company to meet its customer commitments, legal requirements etc. That helps the company to assure not to miss any commitment deadlines, and helps manage the workforce more efficiently. This can be achieved by sending scheduling requests to an enterprise system (database of which is shown as FIG. 2 item 211, but system itself is not shown for clarity). Alternatively, the RCE could be used to provide a scheduling system by itself, using Rules and Constraints directly to formulate one, rather than to rely on an outside package.

By using a RCE to resolve potential conflicts and remove redundancies, and make sure that “must obey” are granted override to general rules, both better, faster and less expensive service can be offered. Further, it is reducing also the risk of litigation, which is an important risk/cost factor in financial services, such as insurance.

The novel art of a system such as the one described in this disclosure may be used in other enterprises or service organizations, in addition to insurance companies. For example, it may be used in brokerage firms, banks, tax advisers, accounting firms or it may be used in government agencies, such as FEMA for assistance management. Further, it is to be understood that the present invention finds applicability within any service organization or enterprise that manages workflow through a central location such a call center. Examples of such service organization or enterprises include, but are not limited to insurance companies (including property, life, and medical insurance companies, etc.), telecommunications service companies (including telephone, cable, satellite television, wireless data network companies, etc.), transportation companies including (airline companies, bus companies, train companies, nationwide limousine service companies, etc.), and retail service companies such as Wal Mart, Home Depot, etc.

For the purposes of this specification, a computer-readable medium includes any mechanism that provides (i.e. stores and/or transmits) information in a form readable by a machine (e.g. computer) for example, a computer-readable medium includes read-only memory (ROM); random access memory (RAM); magnetic disk storage media; optical storage media; flash memory devices; electrical, optical, acoustical or other form of propagated signals (e.g. carrier waves, infra red signals, digital signals, etc.); etc.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method for processing a task, the method comprising:
defining rules which constrain an allocation of the task;
defining constraints which constrain application of the rules;
expressing the allocation of the task as a constraint satisfaction problem based on the rules and the constraints; and
resolving the constraint satisfaction problem.

2. The method of claim 1, wherein the task is a task within a service organization.

3. The method of claim 2, wherein the service organization is an insurance company and the task relates to a processing of an insurance claim.

4. The method of claim 1, wherein the rules comprises business rules.

5. The method of claim 4, wherein the rules comprise legal rules.

6. The method of claim 1, wherein expressing the allocation of the task requires no human input.

7. The method of claim 1, wherein defining the rules comprises extending a rule language used to represent the rules with constraint programming constructs.

8. The method of claim 7, wherein defining the rules comprises creating instances of rules from predefined rule templates.

9. The method of claim 1, wherein the constraint satisfaction problem comprises a minimization of rule violations.

10. The method of claim 9, wherein the minimization of rule violations is based on a weighting of the rules.

11. The method of claim 10, wherein a definition of a rule violation is independent of a rule parameter.

12. The method of claim 11, further comprising checking for inconsistencies in the rules.

13. The method of claim 12, wherein checking for inconsistencies comprises associating a constrained variable with an attribute of the rules; defining a constraint satisfaction problem for the constrained variables for a combination of attributes; and solving the constraint satisfaction problem for the constrained variables.

14. The method of claim 13, wherein the rules are consistent only if the constrained satisfaction problem for the constrained variables has no solutions under over-lapping and under-coverage constraints.

15. The method of claim 14, wherein the rules are inconsistent if the constraint satisfaction problem for the constrained variables has a solution by instantiations of all attributes when over-lapping or under-coverage constraints are defined.

16. The method of claim 15, further comprising providing for preventing a user entering rules that are inconsistent.

17. The method of claim 1, wherein the rules are first rules, the method further comprising defining second rules comprising deadlines for the task and any subtasks related to the task.

18. The method of claim 17, further comprising prioritizing the task and the subtasks based on the second rules.

19. A machine-readable storage medium involving a sequence of instructions executable by the machine to perform a method, the method comprising:
defining rules which constrain an allocation of the task;
defining constraints which constraint application of the rules;
expressing the allocation of the task as a constraint satisfaction problem based on the rules and the constraints; and
resolving the constraint satisfaction problem.

20. The machine-readable storage medium of claim 19, wherein the task is a task within a service organization.

21. The machine-readable medium storage medium of claim 20, wherein the service organization is an insurance company and the task relates to a processing of an insurance claim.

22. A system comprising:
a rules engine to constrain an allocation of a task;
a constraint engine to constrain application of the rules;
the application to express the allocation of the task as a constraint satisfaction problem based on the rules and the constraints; and
to resolve the constraint satisfaction problem.

23. The system of claim 22, wherein the task is a task within a service organization.

24. The system of claim 22, wherein the service organization is an insurance company and the task relates to a processing of an insurance claim.

25. The system of claim 22, wherein the rules comprises business rules.

26. The system of claim 25, wherein comprise legal rules.

27. The system of claim 22, wherein expressing the allocation of a task requires no human input.

28. The system of claim 22, wherein defining the rules comprises extending a rule language used to represent the rules with constraint programming constructs.

29. The system of claim 28, wherein defining the rules comprises creating instances of rules from predefined rule templates.

30. The system of claim 22, wherein the constraint satisfaction problem comprises a minimization of rule violations.
